(19) United States
(12) Patent Application Publication
(10) Pub. No.: US 2016/0034504 A1
(43) Pub. Date: Feb. 4, 2016

(54) EFFICIENT AGGREGATION, STORAGE AND QUERYING OF LARGE VOLUME METRICS

(71) Applicant: AppDynamics, Inc., San Francisco, CA (US)

(72) Inventor: Gautam Borah, Fremont, CA (US)

(21) Appl. No.: 14/449,065

(22) Filed: Jul. 31, 2014

(51) Int. Cl. G06F 17/30

(52) U.S. Cl. CPC G06F 17/30312; G06F 17/30477

(57) ABSTRACT

The present system provide for more efficient processing, storage and querying of metrics from a distributed system from which large volumes of metrics are collected. The present metrics processing system may store billions of performance metrics in a persistence storage system, such as an HBase storage system, for several days, with minimum space required and at the same time retaining a low level data granularity. The reporting queries may use a unique technique to find required metrics in the HBase persistence store using a portion of the key as a bit array. The present metrics processing system may user a very small number of keys to store minute level metrics data for a metric for several hours. The metric values may be pivoted to multiple time-bucketed keys at different times during their life time in the system.

### BACKGROUND OF THE INVENTION

The World Wide Web has expanded to make various services available to the consumer as online web application. Application Performance Management (APM) software exists to collect application and system specific performance metrics to help businesses determine the performance of their web-based systems.

The expansion of software systems in the modern era has created massively distributed systems hosted on hundreds of machines. The amount of performance metrics collected from such a massive system may run into billions of data points per day. If these data points are stored for couple of days for reporting and analysis the space requirement may run into terabytes or petabytes of data.

There is a need to provide for more efficient processing, storage and querying of metrics from such distributed systems.

### SUMMARY OF THE CLAIMED INVENTION

The present technology provides for more efficient processing, storage and querying of metrics from a distributed system from which large volumes of metrics are collected. The present metrics processing system may store billions of performance metrics in a persistence storage system, such as an HBase storage system, for several days, with minimum space required and at the same time retaining a low level data granularity. For example, a minute level granularity may be retained for the high volume of metrics. The reporting queries may use a unique technique to find required metrics in the HBase persistence store using a portion of the key as a bit array. The present metrics processing system may user a very small number of keys, such as for example three keys, to store minute level metrics data for a metric for several hours. The metric values may be pivoted to three time-bucketed keys at different times during their life time in the system. In some instances, only a one key may exist in the system, with the data associated with a different key at different periods of time.

The present metric reporting system may store time series metric data in optimized time rolled up format for faster querying. The system may collect time series data in a maximum time granular level (for example one minute), and then aggregate or rollup the collected data into lower time granular levels. The present system may create multiple of these levels such that the reporting queries would use these levels to apply optimized queries.

An embodiment may include a method for processing metrics. A plurality of payloads which each include time series data may be received. A first time series data associated with a first time range may be stored with a first key. The first time series and at least one other time series data of the plurality of time series data associated with a second time range may be stored with a second key.

Another embodiment may include a method for processing metrics. A metric data for a metric type may be received. One or more groups of data associated with a time period for the metric type may be updated, wherein the groups are associated with at least two different periods of time. At least two groups associated with different periods of time may be provided in response to a query for metric data over a period of time.

### BRIEF DESCRIPTION OF THE DRAWINGS

FIG. 1 illustrates a block diagram of a system for aggregating data.

FIG. 2 illustrates a block diagram of a collector and aggregator.

FIG. 3 illustrates a method for processing metrics.

FIG. 4 illustrates a method for persisting a payload of metrics.

FIG. 5A illustrates a data format for data stored with a first key.

FIG. 5B illustrates a data format for data stored with a second key.

FIG. 5C illustrates a data format for data stored with a third key.

FIG. 6 illustrates a method for aggregating metrics by an aggregator.

FIG. 7 illustrates a block diagram of metric data buckets.

FIG. 8 illustrates a method for providing aggregated data in response to a query.

FIG. 9 is a block diagram of a computer system for implementing the present technology

### DETAILED DESCRIPTION

Embodiments of the present system provide for more efficient processing, storage and querying of metrics from a distributed system from which large volumes of metrics are collected. The present metrics processing system may store billions of performance metrics in a persistence storage system, such as an HBase storage system, for several days, with minimum space required and at the same time retaining a low level data granularity. For example, a minute level granularity may be retained for the high volume of metrics. The reporting queries may us a unique technique to find required metrics in the HBase persistence store using a portion of the key as a bit array. The present metrics processing system may user a very small number of keys, such as for example three keys, to store minute level metrics data for a metric for several hours. The metric values may be pivoted to three time-bucketed keys at different times during their life time in the system. In some instances, at any point in time, only one key may exist in the system with a small overlap with the next key.

The present metric reporting system may store time series metric data in optimized time rolled up format for faster querying. The system may collect time series data in a maximum time granular level (for example one minute), and then aggregate or rollup the collected data into lower time granular levels. The present system may create multiple of these levels such that the reporting queries would use these levels to apply optimized queries.

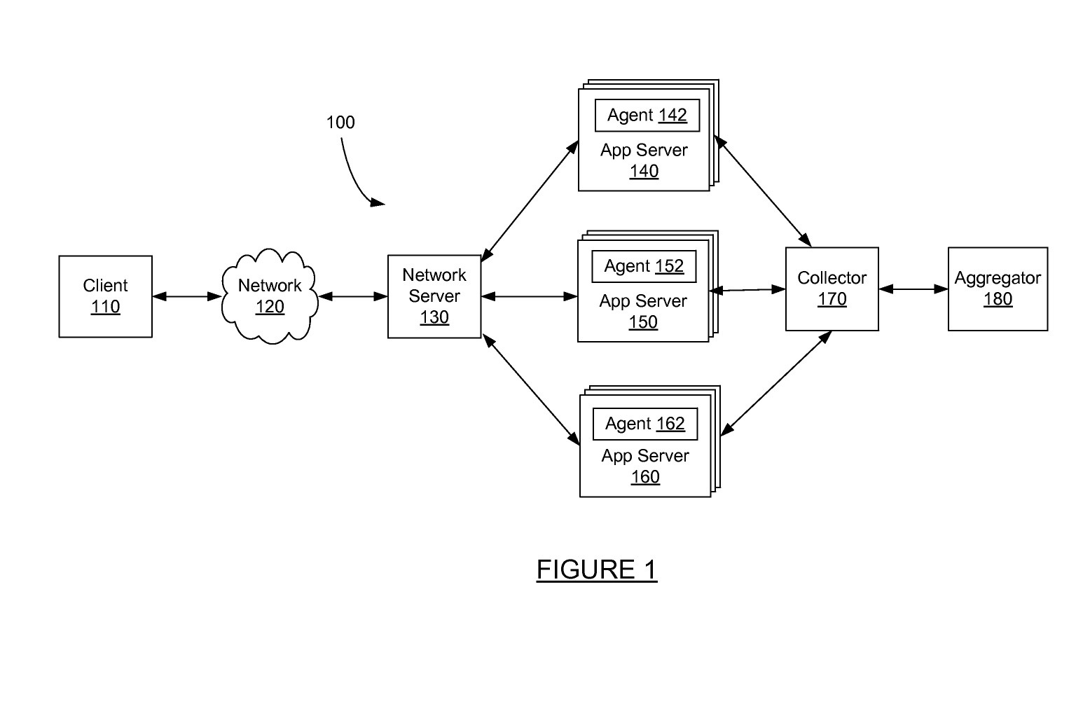

FIG. 1 is a block diagram of a system for aggregating data. The system of FIG. 1 includes client 110, network server 130, application servers 140, 150 and 160, collector 170 and aggregator 180. Client 110 may send requests to and receive responses from network server 130 over network 120. In some embodiments, network server 130 may receive a request, process a portion of the request and send portions of the request to one or more application servers 140-150. Application server 140 includes agent 142. Agent 142 may execute on application server 140 and monitor one or more functions, programs, modules, applications, or other code on application server 140. Agent 142 may transmit data associated with the monitored code to a collector 170. Application servers 150 and 160 include agents 152 and 162, respectively, and also transmit data to collector 170.

Collector 170 may receive metric data and provide the metric data to one or more aggregators 180. Collector 170 may include one or more collector machines, each of which using a logic to transmit metric data to an aggregator 180 for aggregation. Aggregator 180 aggregates data and provides the data for reports to external machines.

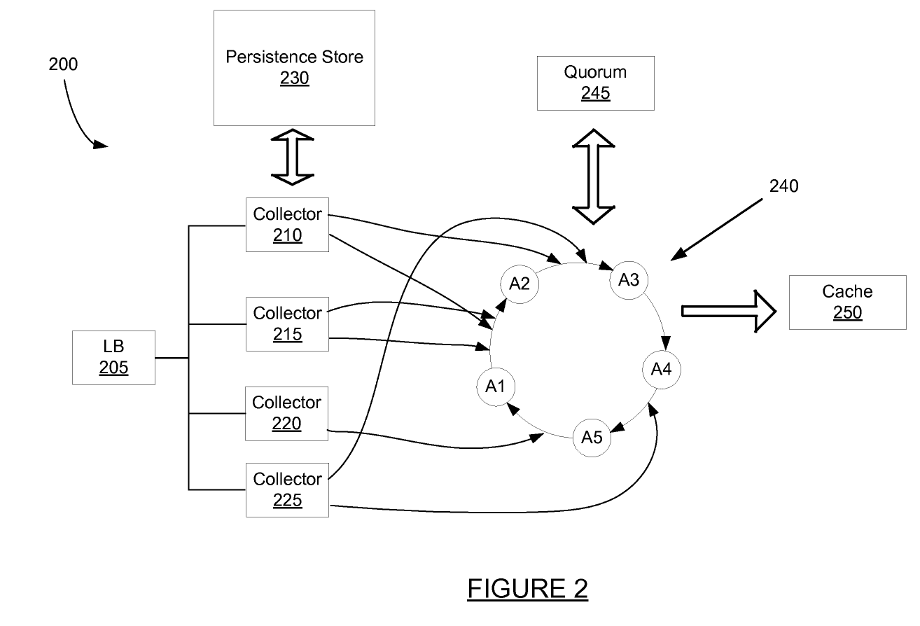

FIG. 2 is a block diagram of a collector and aggregator. The system of FIG. 2 includes load balancer 205, collectors 210, 215, 220 and 225, a persistence store 235, and aggregators 240. The system of FIG. 2 also includes quorum 245 and cache 250. Agents on application servers may transmit metrics to collectors 210-225 through load balance machine 205. The collectors receive the metrics and use logic to route the metrics to aggregators. The logic may include determining a value based on information associated with the metric, such as a metric identifier. In some instances, the logic may include performing a hash on the metric ID. The metric may be forwarded to the aggregator based on the outcome of the hash of the metric ID. In this case, the same hash is used by each and every collector to ensure that the same metrics are provided to the same aggregator.

The collectors may register with a quorum when they start up. In this manner, the quorum may determine when one or more collectors is not performing well and fails to register. In some embodiments, the metrics are sent from the agent to a collector in a table format, for example once per minute.

A persistence store may receive and store the data provided from the collectors to the aggregators. The received data may be stored using a key system, such that a minimal number of keys are used to store time series data sent to the persistence store.

Each aggregator may receive one or more metric types, for example two or three metrics. The metric information may include a sum, count, minimum, and maximum value for the particular metric. An aggregator may receive metrics having a range of hash values. The same metric type will have the same hash value and be routed to the same aggregator.

Aggregation may include, for each received metric, maintaining a plurality of buckets associated with time periods. The buckets may include, for example, a one minute, ten minute, and one hour bucket. Each bucket is updated upon receiving the corresponding metric, and queries for the metric may include a response which includes different sized buckets rather than a large amount of individual data.

Once aggregated, the aggregated data is moved into a cache 250. Data may be stored in cache 250 for a period of time and may eventually be flushed out. For example, data may be stored in cache 250 for a period of eight hours. After this period of time, the data may be overwritten with additional data.

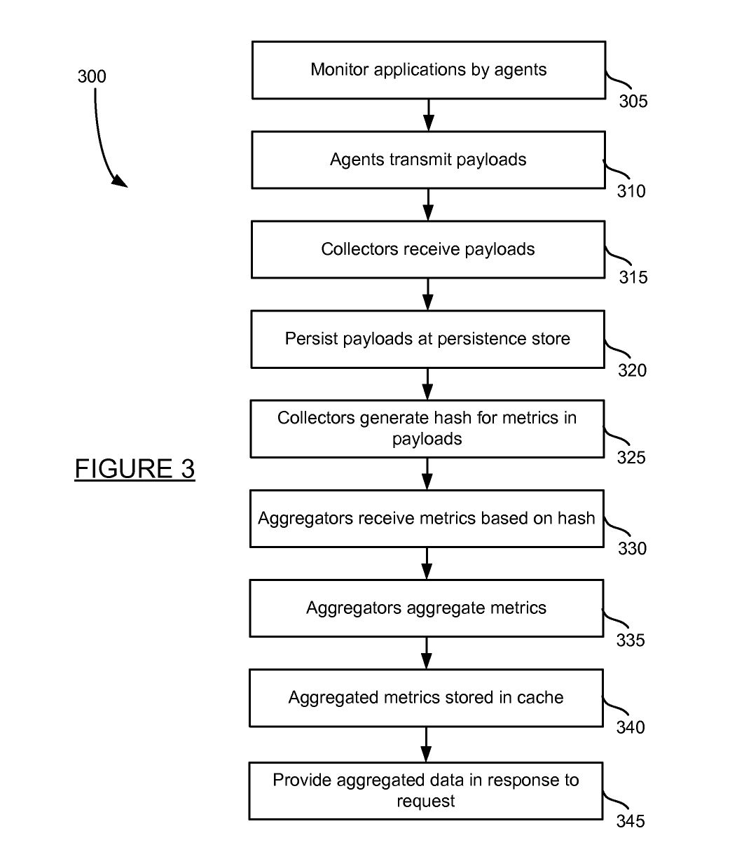

FIG. 3 illustrates a method for processing metrics. First, applications are monitored by agents at step 305. The agents may then transmit payloads to one or more collectors at step 310. The payloads may include metric information associated with the applications and other code being monitored by the particular agent. The metrics may include, for a particular function, method, or other callable code, a minimum response time, a maximum response time, the average response time, and the number of occurrences. One or more collectors may receive a payload of data at step 315. In some embodiments, a collector may receive an entire payload from an agent.

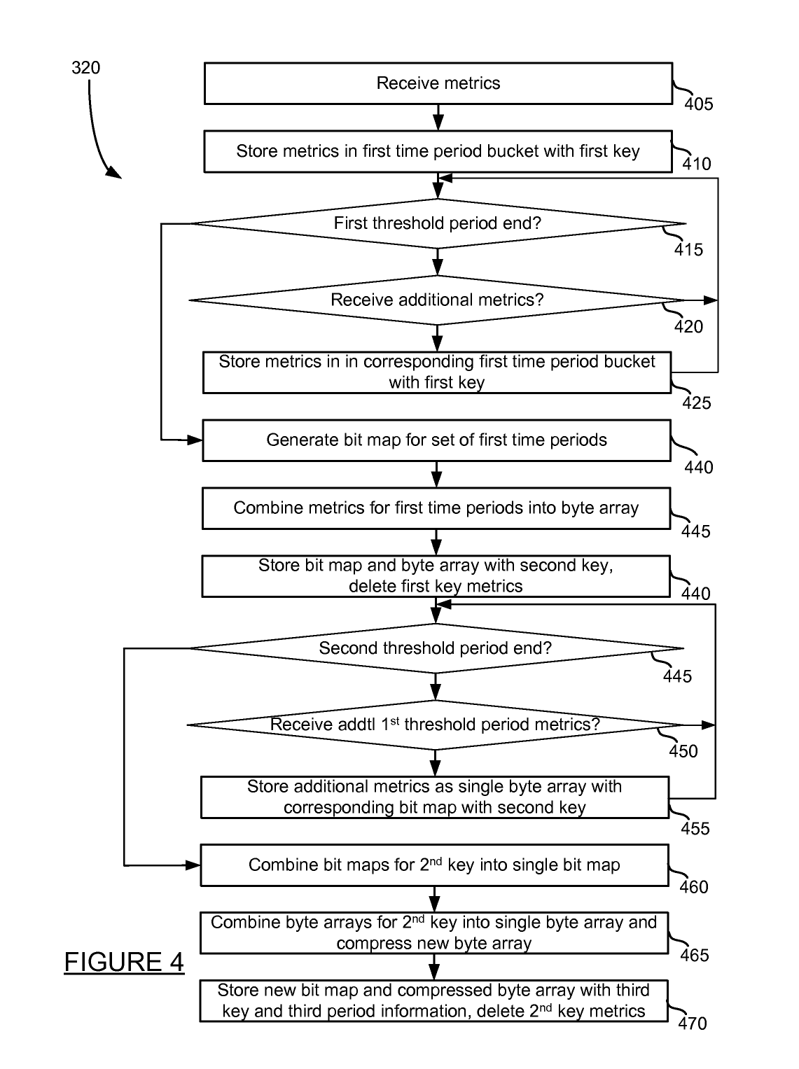

The payloads may be persisted at step 320. To persist the payload, a collector may transmit the payload to a persistence store 230. The persistence store may then store the received payload of metrics. Storing the metrics may include storing the metrics with a particular key based on the time of the metric occurrence. Persisting metrics is discussed in more detail with respect to the method of FIG. 4.

A collector may generate a hash for metrics in the payload at step 325. For each metric, the collector may perform a hash on the metric type to determine a hash value. The metrics may then be transmitted by the collectors to a particular aggregator based on the hash value. The aggregators receive the metrics based on the hash value at step 330.

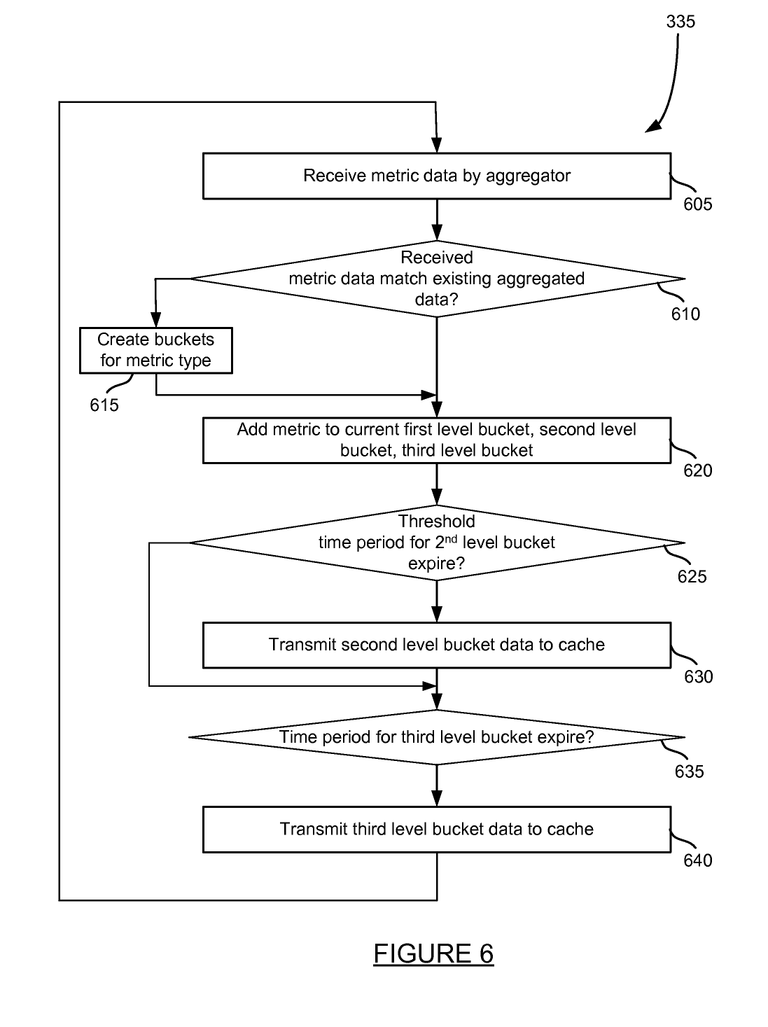

The aggregators may aggregate the metrics at step 335. The metrics may be aggregated to determine the total number of metrics, a maximum, a minimum, and average value of the metric over a period of time. In some instances, the metrics may be aggregated in buckets associated with a period of time in which they occurred. For example, the buckets may include one minute increments, ten minute increments, and one hour increments. For details for aggregating metrics is discussed with respect to the method of FIG. 6.

The aggregated metrics may then be stored in a cache at step 340. A controller or other entity may retrieve the aggregated metrics from the cache for a limited period of time.

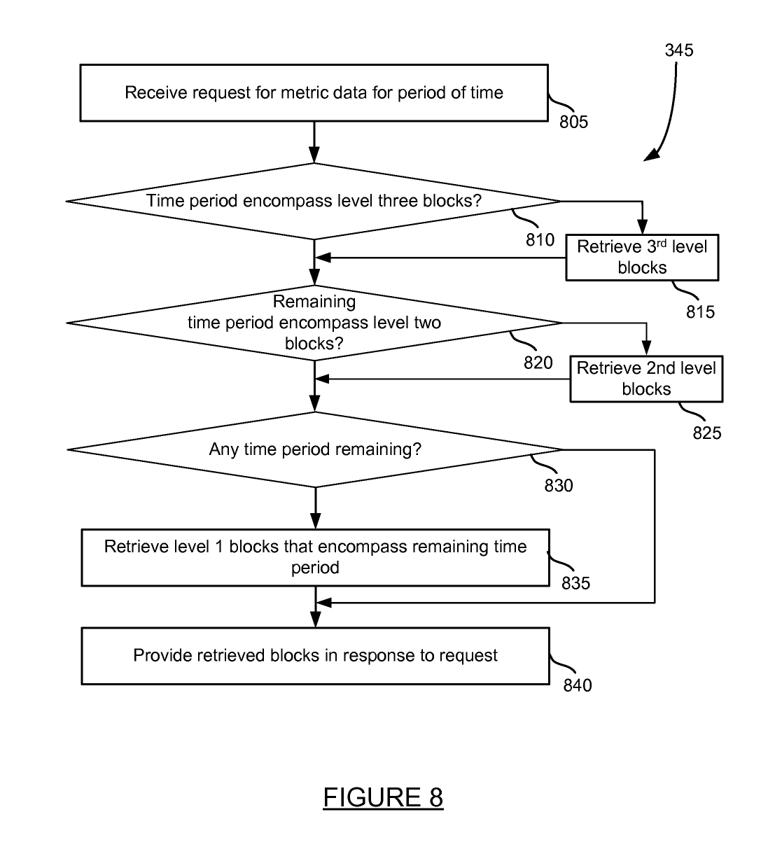

The aggregated data may be provided in response to a request at step 345. A query for data for a particular time period may be received, and a response may be generated with blocks of data having a different size. For example, for a query that requests five and a half hours of data, the response to the query may include five one hour blocks of data, one or more ten minute blocks of data, and several one minute blocks of data. Details regarding providing aggregating data in response to a request is discussed in more detail below with respect to the method of FIG. 8.

FIG. 4 illustrates a method for persisting a payload of metrics. First, metrics are received at step 405. The metrics may be received in a persistence store from a collector. The metrics may be stored in a first time period bucket with a first key at step 410.

The metrics may be stored, eventually, in buckets associated with different time periods. The first time period is typically shorter than the second time period, the second time period is typically shorter than the third time period, and so on. In some instances, the first time period may be one minute.

A determination is made as to whether the first threshold period has ended at step 415. The first threshold period may be a period of time, for example then minutes. In this case, once a threshold of ten minutes has passed, then the data in the first timer period buckets (one minute buckets) is moved from a first key to a second key.

If the first threshold period has ended, the method continues to step 440. If the first threshold period has not ended, then a determination is made as to whether additional metrics are received at step 420. If no additional metrics are received, the method returns to step 415. If additional metrics are received, then the metrics are stored in accordance with a first time period bucket with the first key at step 425. Thus, if additional metrics are received before the first threshold period ends, a first time period bucket is created for those metrics.

In some embodiments, metrics are only stored for a first time period in which metrics are received. For example, if metrics are received during the 1^{st} minute, 2^{nd} minute, 5^{th} minute and 20^{th} minute, then a data entry is created and stored for each of those minutes and only those minutes.

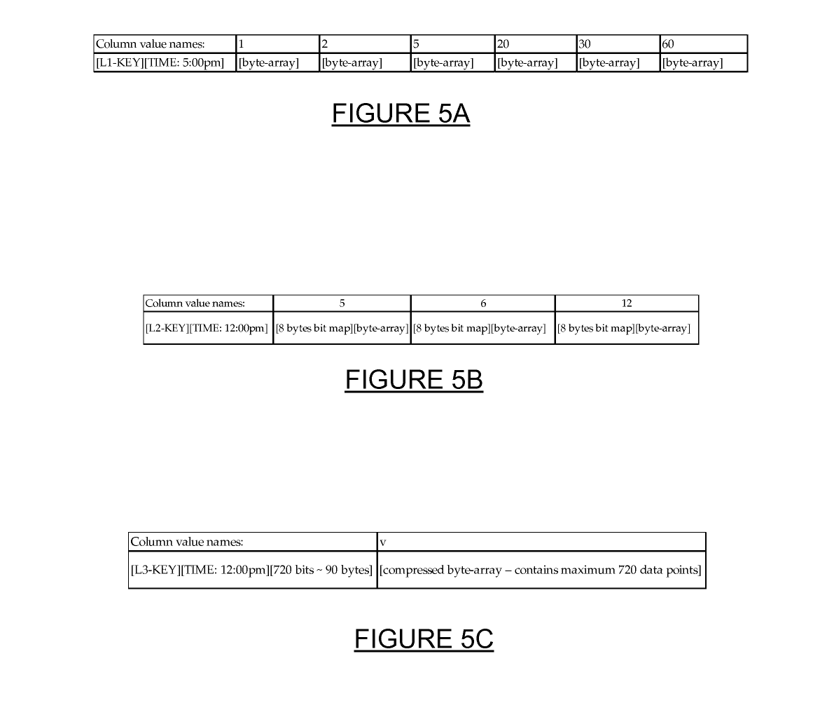

FIG. 5A illustrates metrics stored associated with the first key. The table of 5A includes a first key L1-key and an indicator at the time of 5:00. Metrics are received for a first minute, second minute, fifth minute, minute 20, minute 30, and minute 60. For each of these minute time periods, a byte array is stored with the metric data received. For minutes in which no metrics are received, there is no entry in the table.

After metrics are stored in the corresponding first time period bucket in which they are received, the method of FIG. 4 returns to step 415. Once the first threshold period ends, a bitmap may be generated for the set of the first time periods at step 440. The bitmap may indicate which minutes within the first time period that metrics have been received. Metrics are then combined for the first time periods into a single byte array at step 445. The bitmap and the byte array are then stored with a second key at step 440. The metrics associated with the first key are then deleted or flushed away to make room for the next first period's data.

FIG. 5B illustrates a bitmap and byte array stored with a second key. The table for FIG. 5B includes a first column having the second key and a corresponding time chunk and sets of bitmaps and byte arrays. For example, in FIG. 5B, the first data field includes a bitmap as well as a byte array for a time of 5:00. The byte array for the time of 5:00 in FIG. 5B includes the combination of all the byte arrays in the table of FIG. 5 corresponding to 5:00.

After the bitmap and byte array are stored with the second key, a determination is made as to whether the second threshold period ends at step 445. The second threshold period may be a period of ten minutes, an hour, or some other time period. If the second threshold period has ended, the method of FIG. 4 continues to step 460. If the threshold period has not ended, a determination is made as to whether additional first threshold period metrics have been received at step 450. If no metrics have been received at step 450, the method at FIG. 4 continues to step 445. If additional metrics have been received, the additional metrics are stored as a single byte array with a corresponding bitmap along with a second key at step 455.

In FIG. 5B, an additional first threshold period metrics is stored for a time associated with 6:00, and includes an eight byte bitmap as well as a byte array. After storing the additional metrics, the method of FIG. 4 continues to step 445.

Once the second threshold period ends, bitmaps are combined for the second key into a single bitmap at step 460. The byte arrays for the second key are then combined into a single byte array and compressed into a new byte array at step 465. The new bitmap and the compressed byte array are then stored with the third key and a third period information at step 470. An example of the data format for data stored with a third key is illustrated in FIG. 5C. Upon storing this information, the second key metrics are then deleted to make room for additional data.

FIG. 6 illustrates a method for aggregating metrics by an aggregator. First, metric data may be received by an aggregator at step 605. The metric data may be provided to one or more aggregators from one or more collectors. Next, a determination is made as to whether the received metric data matches existing aggregated data at step 610. If there is no existing aggregated data that matches the received metric data, buckets for the metric type are created at step 615. The buckets may include any number of buckets per design preference. For example, the buckets may include a one minute bucket, ten minute bucket and one hour bucket. After creating the buckets, the method continues to step 620.

If the received metric data does match existing aggregated data, the metric is added to the current first level bucket, second level bucket, and third level bucket at step 620. Adding the metric data to a particular bucket may include summing counts of the data, sorting the data to determine the overall minimum and overall maximum, and processing the data to determine the average of the data.

A determination is made as to whether the threshold time period for the second level bucket has expired at step 625. If the time period for the second level bucket has not expired, the method continues to step 635. If the threshold time period for the second level bucket has expired, then the second level bucket data is transmitted to the cache at step 630. Providing the data to cache makes the data available for requests by other entities and frees up memory space at the aggregator.

A determination is made as to whether the time period for the third level bucket has expired at step 635. If the time period has not expired, the method at FIG. 6 returns to step 605. If the time period for the third level bucket has expired, the third level bucket data is transmitted to the cache at step 640 and the method of FIG. 6 returns to step 605.

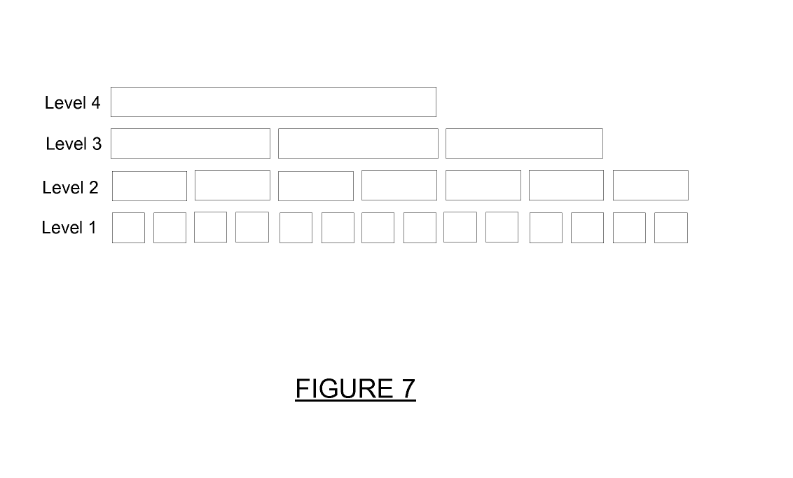

FIG. 7 illustrates a block diagram of metric data buckets. In the example of FIG. 7, there are four levels of buckets. Each level one bucket spans over a particular time period. The level one time periods are of equal length and do not overlap. A level two bucket spans for a period of time equivalent to about two level one buckets. A level three bucket includes two level two buckets. A level four bucket includes two level three buckets. Any number of bucket levels may be used, and each level may encompass any number of lower level buckets as determined design preference.

FIG. 8 illustrates a method for providing aggregated data in response to a query. First, a query or request is received from metric data for a period of time at step 805. A determination is then made as to whether the requested time period encompasses a level three block at step 810. The level three block in this example is the highest level block, and spans across the largest period of time. Hence, if the time period includes one or more highest level blocks, retrieving those blocks may be more time efficient than retrieving multiple blocks of lower level data. If the time period encompasses a level three block, the corresponding third level blocks are retrieved at step 815 and the method continues to step 820. If the time period does not encompass any level three blocks the method continues to step 820.

A determination is made as to whether the remaining time period encompasses level two blocks at step 820. If the remaining time period does not encompass any level two blocks, the method continues to step 830. If the remaining time period does encompass any level two blocks, those level two blocks are retrieved at step 825 and the method continues to step 830.

A determination is made as to whether there is any time period remaining at step 830. If there is no time period remaining for which to retrieve data, the retrieved blocks are provided in response to the request at step 840. If there is any time period remaining, the lowest level blocks, in this example level one blocks, are retrieved that encompass the remaining time period at step 835. Those level one blocks are then provided along with any other retrieved blocks in response to the request at step 840.

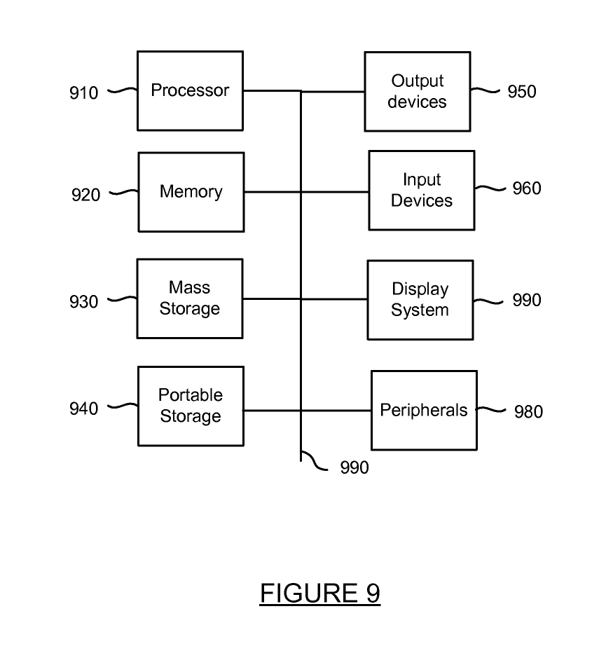

FIG. 9 is a block diagram of a computer system for implementing the present technology. System 900 of FIG. 9 may be implemented in the contexts of the likes of client 110, network server 130, application servers 140-160, collectors 170 and aggregators 180. A system similar to that in FIG. 9 may be used to implement a mobile device, such as a smart phone that provides client 110, but may include additional components such as an antenna, additional microphones, and other components typically found in mobile devices such as a smart phone or tablet computer.

The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing embodiments of the present invention for purposes of loading that software into main memory 910.

Portable storage device 940 operates in conjunction with a portable non-volatile storage medium, such as a floppy disk, compact disk or Digital video disc, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys. Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 receives textual and graphical information, and processes the information for output to the display device.

Peripherals 980 may include any type of computer support device to add additional functionality to the computer system. For example, peripheral device(s) 980 may include a modem or a router.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

When implementing a mobile device such as smart phone or tablet computer, the computer system 700 of FIG. 7 may include one or more antennas, radios, and other circuitry for communicating over wireless signals, such as for example communication using Wi-Fi, cellular, or other wireless signals.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for processing metrics, comprising:
receiving a plurality of payloads which each include time series data;
storing a first time series data associated with a first time range with a first key; and
storing the first time series and at least one other time series data of the plurality of time series data associated with a second time range with a second key.

2. The method of claim 1, further comprising generating a bit map for the time series data stored with the second key.

3. The method of claim 1, further comprising storing the time series data in a byte array associated with the first key and a time the data was received.

4. The method of claim 3, further comprising storing a plurality of byte arrays associated with first key as a single byte array associated with the second key.

5. The method of claim 1, further comprising storing the time series data associated with the second key as a compressed byte array associated with a third key.

6. The method of claim 1, further comprising storing a plurality of bit maps associated with the second key as a single bit map associated with the third key.

7. The method of claim 1, wherein the first time series and at least one other time series data of the plurality of time series data is stored with the second key after a threshold period of time has been satisfied.

8. The method of claim 1, further comprising allowing the time series data associated with the first key to be overwritten once the time series data associated with the first key is associated with the second key.

9. A method for processing metrics, comprising:
receiving metric data for a metric type;
updating one or more groups of data associated with a time period for the metric type, wherein the groups are associated with at least two different periods of time; and
providing at least two groups associated with different periods of time in response to a query for metric data over a period of time.

10. The method according to claim 9, wherein the groups of data are provided to a cache for receiving queries.

11. A non-transitory computer readable storage medium having embodied thereon a program, the program being executable by a processor to perform a method for processing metrics, the method comprising:
receiving a plurality of payloads which each include time series data;
storing a first time series data associated with a first time range with a first key; and
storing the first time series and at least one other time series data of the plurality of time series data associated with a second time range with a second key.

12. A system for processing metrics, comprising:
a processor;
a memory; and
one or more modules stored in memory and executable by a processor to receive a plurality of payloads which each include time series data, store a first time series data associated with a first time range with a first key, and store the first time series and at least one other time series data of the plurality of time series data associated with a second time range with a second key.
